(19) United States
(12) Patent Application Publication
(10) Pub. No.: US 2006/0104005 A1
(43) Pub. Date: May 18, 2006

(54) Pad for reducing/removing static electricity from air, gas, liquid forms and liquid fuel molecules

(75) Inventor: Thakon Sawatdikumthon, Bangkok (TH)

Correspondence Address: VOLPE AND KOENIG, P.C., UNITED PLAZA, SUITE 1600, 30 SOUTH 17TH STREET, PHILADELPHIA, PA, 19103, US

(73) Assignee: Heat Company Limited, Bangkok (TH)

(21) Appl. No.: 11/210,943

(22) Filed: Aug. 24, 2005

(30) Foreign Application Priority Data
Nov. 15, 2004 (TH) 095412

(51) Int. Cl. H02H 1/00

(52) U.S. Cl. 361/212

(57) ABSTRACT

A static electricity reduction/remover pad for air, gas, liquid forms and liquid fuels is presented and is made up of the following elements: aluminum 71.9%, gold 24.2%, silicon 0.1-0.7%, manganese 0.1-1.5%, copper 0.2%, iron 0.5-1.5%. The elements are layered and made into thin film/foil like sheets. The thin film or foil is then further attached to a sheet of synthetic fiber. The resulting product is the static electricity reduction/remover pad for air, gas, liquid forms, and liquid fuel molecules with two thin gold element sheets attached on both sides of the pad (top & bottom). The static electricity reduction/remover pad for air, gas, liquid forms, and liquid fuel molecules can be attached to, stuck to, strapped around, or wrapped around any piping or tubing, in which air, gas, liquid forms, and liquid fuel molecules must pass through, to reduce/remove accumulated static electricity in such molecules, and which un-bonds the molecules and enables free movement of such molecules.

### FIELD OF THE INVENTION

Technology related to the bonding of molecules resulting from friction.

### BACKGROUND

Electrostatic is generated from friction caused by the movement of air, gas, liquid forms, and liquid fuel molecules against each other, or against the surface of tubes or piping. Static electricity accumulates on the air, gas, liquid forms, and liquid fuel molecules causing these molecules to bond to each other.

### SUMMARY

The static remover pad is made up of aluminum 71.9%, gold 24.2%, silicon 0.1-0.7%, manganese 0.1-1.5%, copper 0.2%, iron 0.5-1.5%, which are layered to form a thin film or foil. Then, glue is used to attach the film or foil to a pad of synthetic fiber. The combined product is the resulting static electricity reduction/remover pad.

### BRIEF DESCRIPTION OF THE DRAWINGS

FIG. 1 is a top plan view of the static electric remover pad of the present invention.

FIG. 2 is a perspective view of the static electric remover pad of the present invention.

FIG. 3 side plan view to the static electric remover pad of the present invention.

### DETAILED DESCRIPTION OF THE PREFERRED EMBODIMENTS

### Introduction to the Embodiments

The gold film/foil found in the static electricity reduction/remover pad is used to reduce/remove accumulated static electricity from air, gas, liquid forms, and liquid fuels and is made up of aluminum 71.9%, gold 24.2%, silicon 0.1-0.7%, manganese 0.1-1.5%, copper 0.2%, iron 0.5-1.5% layered to form a thin film or foil.

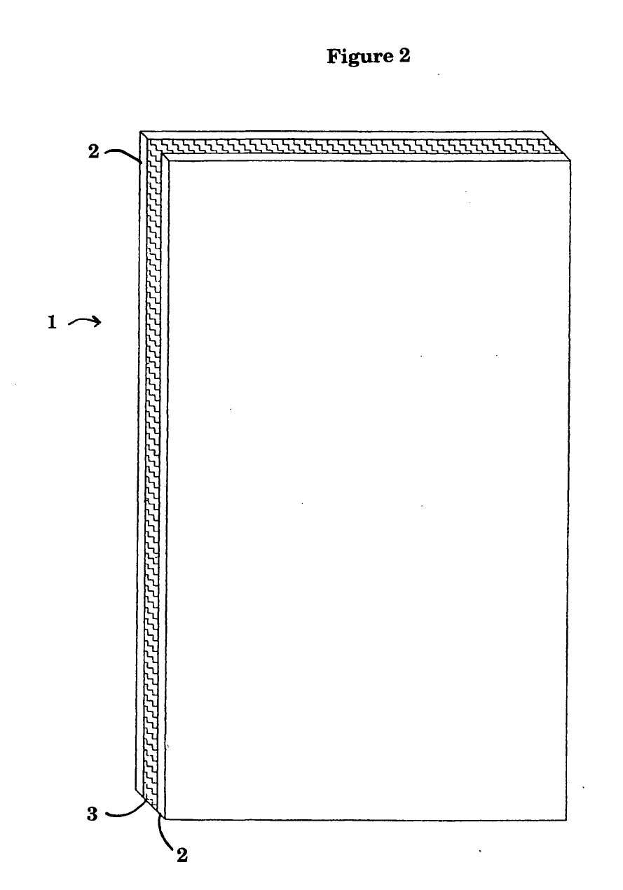

The development or modification of the pad-like design, the use of the film or foil concept of any kind to be attached to any synthetic fiber sheet to develop the static electricity reduction/remover pad applicable to air, gas, liquid forms, and liquid fuel as shown in FIG. 2. For example: polyester film/foil; vinyl film/foil; PVC film/foil. Alternatively, the film or foil can be attached to a layer of aluminum foil.

The present invention relates to un-bonding air, gas, liquid forms, and liquid fuel molecules by removing accumulated static electricity from the above molecules enabling increased efficiency in the combustion of air, gas, liquid forms, and liquid fuel, and to reduce waste and exhaust emissions from such combustion.

In the past, combustion of fuel molecules and air molecules has been less than efficient, causing waste of fuel and causing residue build-up. To increase the efficiency of combustion, the static electricity reduction/remover pad was developed to reduce the level of static electricity generated from the friction of air and fuel molecules passing through piping or tubing. By reducing/removing static electricity accumulated on each molecule, this frees up air and fuel molecules, and enables a larger surface contact area of air and fuel molecules along with enabling air and fuel molecules to mix more thoroughly. With a greater surface contact area, and with a better mix of air and fuel molecules, combustion occurs with greater efficiency.

The static electricity reduction/remover pad of the present invention can be used for any liquid fuel and gas system that involves such liquid fuel or gas flowing through piping or tubing. This system to reduce/remove static electricity also encompasses any process involving the movement of air through a pipe or tube.

### DESCRIPTION

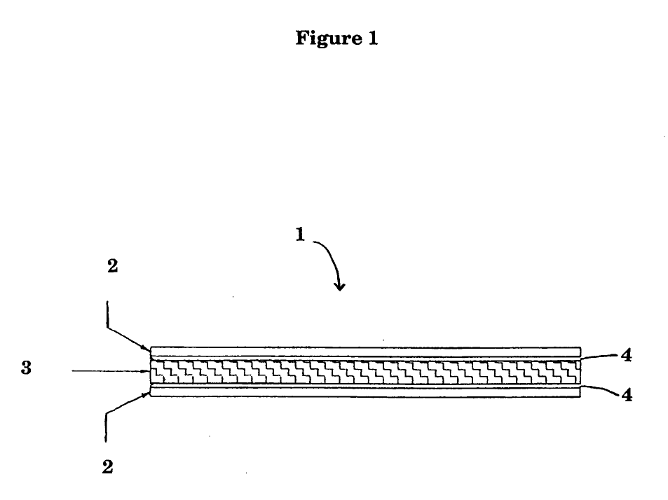

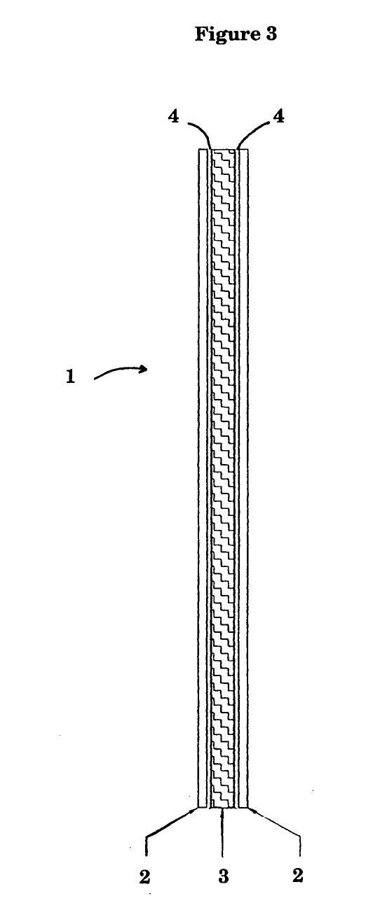

FIGS. 1-3 show the static electricity reduction/remover pad 1 of the present invention. The pad 1, which is applicable for air, gas, liquid forms and liquid fuel molecules, is composed of aluminum 71.9%, gold 24.2%, silicon 0.1-0.7%, manganese 0.1-1.5%, copper 0.2%, iron 0.5-1.5% layered to form a thin film or foil. The combination of the above elements is made into a thin film or foil. Then, an adhesive 4 is used to attach the gold film or foil 2 to a synthetic fiber 3, as shown in FIG. 1. The resulting product is a pad 1 that removes or reduces the accumulation of static electricity on such molecules.

The static electricity reduction/remover pad 1 acts to extract/remove static electricity that has accumulated as a result of friction caused by air, gas, liquid forms, and liquid fuel molecules moving through piping or tubing, which causes such molecules to bond or clump together. By either sticking/attaching the static electricity reduction/remover pad 1 externally, or by wrapping the piping/tubing in which air, gas, liquid forms, and liquid fuel molecules must move through, the result is the immediate reduction/dissipation of static electricity accumulated amongst air, gas, liquid forms, and liquid fuel molecules, thus freeing up these molecules and enabling them to better mix with oxygen for a more efficient combustion.

The present invention also provides for a method for removing static electricity from gasses or liquids, comprising the steps of: providing a pad comprising at least one layer comprised of aluminum, gold, silicon, manganese, copper, and iron, which form a foil 2; and a synthetic fiber sheet 3 attached to the foil; providing a conduit through which gas or liquid flows; and placing the pad on or wrapping the pad around the conduit.

As above, the foil 2 is comprised of 71.9% aluminum, 24.2% gold, 0.1-0.7% silicon, 0.1-1.5% manganese, 0.2% copper, and 0.5-1.5% iron. The pad 1 removes accumulated static electricity from said gas or liquid as the gas or liquid passes through the portion of conduit wrapped with the pad. If fuel is passing through the conduit, combustion of the fuel is more efficient after passing through the portion of conduit wrapped with the pad.

Any modifications or changes made by inventors and/or specialists in this field can be construed as to be prohibited under this patent license as stipulated in the attachment of this license encompassing the modification of design specifications, element mix, layer thickness, number of layers, change of elements used or shape of the static electricity reduction/remover pad.

What is claimed is:

1. A pad for removing static electricity from gasses or liquids, the pad comprising at least one layer comprised of aluminum, gold, silicon, manganese, copper, and iron, which form a foil.

2. The pad of claim 1, wherein the foil is comprised of 71.9% aluminum, 24.2% gold, 0.1-0.7% silicon, 0.1-1.5% manganese, 0.2% copper, and 0.5-1.5% iron.

3. The pad of claim 1, further comprising a synthetic fiber sheet attached to the foil.

4. The pad of claim 3, wherein the synthetic fiber sheet is made up of a material selected from the group consisting of: polyester; vinyl; polyvinylchloride (PVC), or a combination thereof.

5. The pad of claim 3, wherein the synthetic fiber sheet is arranged between two foil layers.

6. The pad of claim 3, wherein the pad is placed on or wrapped around a conduit for gas or liquid and removes accumulated static electricity from said gas or liquid as the gas or liquid passes through the portion of conduit wrapped with the pad.

7. The pad of claim 6, wherein the liquid is a liquid fuel.

8. The pad of claim 7, wherein combustion of the fuel is more efficient after passing through the portion of conduit wrapped with the pad.

9. A pad for removing static electricity from gasses or liquids, the pad comprising at least one layer comprised of 71.9% aluminum, 24.2% gold, 0.1-0.7% silicon, 0.1-1.5% manganese, 0.2% copper, and 0.5-1.5% iron which form a foil.

10. The pad of claim 9, further comprising a synthetic fiber sheet attached to the foil.

11. The pad of claim 10, wherein the synthetic fiber sheet is made up of a material selected from the group consisting of: polyester; vinyl; polyvinylchloride (PVC), or a combination thereof.

12. The pad of claim 10, wherein the synthetic fiber sheet is arranged between two foil layers.

13. The pad of claim 10, wherein the pad is placed on or wrapped around a conduit for gas or liquid and removes accumulated static electricity from said gas or liquid as the gas or liquid passes through the portion of conduit wrapped with the pad.

14. The pad of claim 13, wherein the liquid is a liquid fuel.

15. The pad of claim 14, wherein combustion of the fuel is more efficient after passing through the portion of conduit wrapped with the pad.

16. A method for removing static electricity from gasses or liquids, comprising the steps of:
a) providing a pad comprising:
i) at least one layer comprised of aluminum, gold, silicon, manganese, copper, and iron, which form a foil; and
ii) a synthetic fiber sheet attached to the foil;
b) providing a conduit through which gas or liquid flows; and
c) placing the pad on or wrapping the pad around the conduit.

17. The method of claim 16, wherein the foil is comprised of 71.9% aluminum, 24.2% gold, 0.1-0.7% silicon, 0.1-1.5% manganese, 0.2% copper, and 0.5-1.5% iron.

18. The method of claim 16, wherein the pad removes accumulated static electricity from said gas or liquid as the gas or liquid passes through the portion of conduit wrapped with the pad.

19. The method of claim 18, wherein the liquid is a liquid fuel.

20. The method of claim 19, wherein combustion of the fuel is more efficient after passing through the portion of conduit wrapped with the pad.
